(19) United States
(12) Patent Application Publication
(10) Pub. No.: US 2016/0175976 A1
(43) Pub. Date: Jun. 23, 2016

(54) SYSTEMS AND METHODS FOR DETERMINING A WELD TORCH LOCATION

(71) Applicant: ILLINOIS TOOL WORKS INC., Glenview, IL (US)

(72) Inventors: Marc Lee Denis, Lena, WI (US); Christopher Hsu, Appleton, WI (US)

(21) Appl. No.: 14/575,811

(22) Filed: Dec. 18, 2014

(51) Int. Cl. B23K 9/12; G01S 5/18; B23K 9/10

(52) U.S. Cl. CPC B23K 9/126; B23K 9/10; G01S 5/18

(57) ABSTRACT

A welding system having a modulation circuit, a weld torch, and a sensor system is provided. The modulation circuit configured to modulate a welding current with a randomized signal to generate a modulated welding current. The weld torch is configured to receive the modulated welding current and produce a welding arc based on the received modulated welding current. The audio signal is generated when the weld torch produces the welding arc based on the modulated welding current. The sensor system detects the audio signal with one or more sensors, and the one or more sensors provide information regarding the audio signal to a central processing unit of the sensor system. The central processing unit calculates position information for the weld torch based on the information regarding the audio signal.

### BACKGROUND

The present disclosure relates generally to welding systems and methods, and more particularly to systems and methods for determining a location of a weld torch within a weld location.

Welding is a process that has increasingly become utilized in various industries and applications. Such processes may be automated in certain contexts, although a large number of applications continue to exist for manual welding operations. In both cases, such welding operations rely on a variety of types of equipment to ensure the supply of welding consumables (e.g., wire feed, shielding gas) is provided to the weld in appropriate amounts at the desired time.

In manual welding operations, the weld torch may be operated by a welding operator. In such situations, it may be beneficial for the welding system to have location information (e.g., position) of the weld torch in order to ensure that the welding process is executed in an efficient and proper manner. For example, in certain manual welding situations, the operator may need to weld according to a particular sequence or along a particular direction. Accordingly, it may be beneficial to provide for systems and methods that precisely determine the location of a welding component (e.g., weld torch) within the weld location, thereby helping to improve the quality and efficiency of the welding process.

### BRIEF DESCRIPTION

Certain embodiments commensurate in scope with the originally claimed embodiments are summarized below. These embodiments are not intended to limit the scope of the present disclosure, but rather these embodiments are intended only to provide a brief summary of possible forms of the present disclosure. Indeed, the present disclosure may encompass a variety of forms that may be similar to or different from the embodiments set forth below.

In a first embodiment, a welding system is provided. The system includes a modulation circuit, a weld torch, and a sensor system. The modulation circuit configured to modulate a welding current with a randomized signal to generate a modulated welding current. The weld torch configured to receive the modulated welding current, and the weld torch is configured to produce a welding arc based on the received modulated welding current. An audio signal is generated when the weld torch produces the welding arc based on the modulated welding current. One or more sensors of the sensor system are disposed in a welding region proximate to the weld torch, and each sensor of the one or more sensors is configured to detect the audio signal. The sensor system is configured to provide information regarding the audio signal. A central processing unit disposed within the sensor system is configured to receive the information regarding the audio signal from each sensor of the one or more sensors. The central processing unit is configured to calculate position information for the weld torch based on the information regarding the audio signal received from the one or more sensors.

In another embodiment, a system is provided. The system includes a weld torch configured to produce a welding arc, a transmitter disposed within the weld torch, and a sensor system. The transmitter is configured transmit an audio signal into a welding region. The sensor system includes one or more sensors and a central processing unit. The one or more sensors of a sensor system disposed in the welding region proximate to the weld torch, and each sensor of the one or more sensors is configured to detect the audio signal and calculate distance information or time delay information based on the detected audio signal. The central processing unit of the sensor system configured to receive the distance information or the time delay information from each sensor of the one or more sensors. The central processing unit is configured to calculate position information for the weld torch based on the distance information or the time delay information received from the one or more sensors.

In a further embodiment, a method is provided. The method includes generating an audio signal from a weld torch disposed within a weld region of a welding system and detecting the audio signal with one or more sensors of a sensor system disposed within the weld region. The method also includes determining, with each of the one or more sensors, distance information based on the detected audio signal. The distance information comprises a distance between each of the one or more sensors and the weld torch. The method also includes transmitting the distance information from each of the one or more sensors to a central processing unit of the sensor system. The method also includes determining position information of the weld torch within the weld region based on the distance information received from each of the one or more sensors.

### DRAWINGS

These and other features, aspects, and advantages of the presently disclosed embodiments will become better understood when the following detailed description is read with reference to the accompanying drawings in which like characters represent like parts throughout the drawings, wherein:

FIG. 1 is a block diagram of an embodiment of a welding system utilizing a power supply equipped with a modulation circuit, a weld torch, and a sensor system having one or more sensors disposed within a weld region, in accordance with aspects of the present disclosure;

FIG. 2 is a flow diagram of an embodiment of a method for determining a position of the weld torch within the welding region that may be used by the welding system of FIG. 1, in accordance with aspects of the present disclosure;

FIG. 3 is a block diagram of an embodiment of the welding system of FIG. 1 utilizing the power supply, the weld torch equipped with a transmitter, and the sensor system having the one or more sensors disposed within the weld region, in accordance with aspects of the present disclosure;

FIG. 4 is a flow diagram of an embodiment of a method for determining a position of the weld torch within the welding region that may be used by the welding system of FIG. 3, in accordance with aspects of the present disclosure; and

FIG. 5 is a block diagram of an embodiment of a system for determining a position of the weld torch of FIG. 1 or FIG. 3, in accordance with aspects of the present disclosure.

### DETAILED DESCRIPTION

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

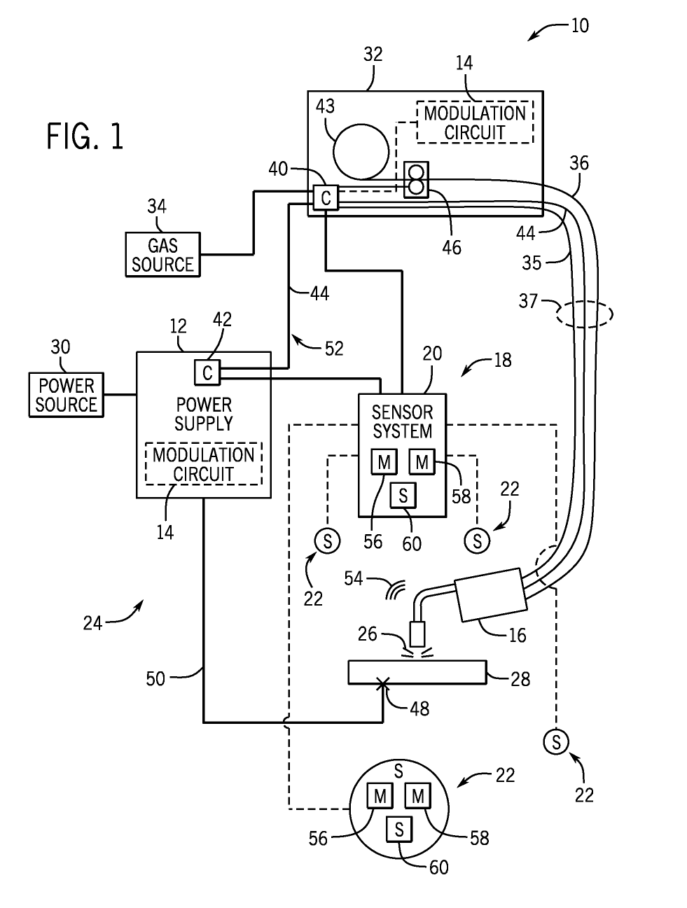

FIG. 1 is a block diagram of an embodiment of a welding system 10 utilizing a power supply 12 equipped with a modulation circuit 14, a weld torch 16, and a sensor system 18 having a central processing unit 20 and one or more sensors 22 disposed within a weld region 24. In particular, the modulation circuit 14 and the sensor system 18 may be configured to determine the location of the weld torch 16 within the weld region 24 during a welding operation. Specifically, the sensor system 18 may be configured to calculate position information (e.g., location information) of the weld torch 16 within the weld region 24, and convey this information to one or more components of the welding system 10 (e.g., the power supply 12), as further described in detail below.

The welding system 10 is designed to produce a welding arc 26 with a workpiece 28 (e.g., pipe). The welding arc 26 may be generated by any type of welding system or process, and may be oriented in any desired manner. For example, such welding systems may include gas metal arc welding (GMAW) systems, and may utilize various programmed waveforms and settings. The welding system 10 includes the power supply 12 (e.g., engine-driven generator in some embodiments) that will typically be coupled to a power source 30, such as a power grid, an engine, or a combination thereof (e.g., hybrid power). Other power sources may, of course, be utilized including generators and so forth. In the illustrated embodiment, a wire feeder 32 is coupled to a gas source 34 and the power source 30, and supplies welding wire 36 to the weld torch 16. The weld torch 16 is configured to generate the welding arc 26 between the weld torch 16 and the workpiece 28. The welding wire 36 is fed through the weld torch 16 to the welding arc 26, melted by the welding arc 26, and deposited on the workpiece 28.

The wire feeder 32 will typically include wire feeder control circuitry 40, which regulates the feed of the welding wire 36 from a spool 43 and commands the output of the power supply 12, among other things. Similarly, the power supply 12 may include power supply control circuitry 42 for controlling certain welding parameters and arc-starting parameters. In certain embodiments, the wire feeder control circuitry 40 or the power supply control circuitry 42 may include software, hardware, or a combination thereof. For example, in certain embodiments, the wire feeder control circuitry 40 and/or the power supply control circuitry 42 may include a processor and memory configured to store instructions to be executed by the processor. In some embodiments, the wire feeder control circuitry 40 may communicate with the power supply control circuitry 42 through a weld cable 44 that is also used to provide power to the wire feeder 32. The spool 43 of the wire feeder 32 will contain a length of welding wire 36 that is consumed during the welding operation. The welding wire 36 is advanced by a wire drive assembly 46, typically through the use of an electric motor under control of the control circuitry 40. In addition, the workpiece 28 is coupled to the power supply 12 by a clamp 48 connected to a work cable 50 to complete an electrical circuit when the welding arc 26 is established between the weld torch 16 and the workpiece 28. In certain embodiments, a bundled cable 37 may include the weld cable 44, the welding wire 36, and a gas hose 35 (configured to provide and/or route the gas source 34), and the bundled cable may be configured to supply the welding wire 36, the power (modulated and/or unmodualted), and the gas to the weld torch 16.

Placement of the weld torch 16 at a location proximate to the workpiece 28 allows electrical current, which is provided by the power supply 12 and routed to the weld torch 16, to arc from the weld torch 16 to the workpiece 28. As described above, this arcing completes an electrical circuit that includes the power supply 12, the weld torch 16, the workpiece 28, and the work cable 50. Particularly, in operation, electrical current passes from the power supply 12, to the weld torch 16, to the workpiece 28, which is typically connected back to the power supply 12 via the work cable 50. The arc generates a relatively large amount of heat that causes part of the workpiece 28 and the filler metal of the welding wire 36 to transition to a molten state that fuses the materials, forming the weld.

In certain embodiments, to shield the weld area from being oxidized or contaminated during welding, to enhance arc performance, and to improve the resulting weld, the welding system 10 may also feed an inert shielding gas to the weld torch 16 from the gas source 34. It is worth noting, however, that a variety of shielding materials for protecting the weld location may be employed in addition to, or in place of, the inert shielding gas, including active gases and particulate solids. Moreover, in other welding processes, such gases may not be used, while the techniques disclosed herein are equally applicable.

Although FIG. 1 illustrates a GMAW system, the presently disclosed techniques may be similarly applied across other types of welding systems, including gas tungsten arc welding (GTAW) systems and shielded metal arc welding (SMAW) systems, among others. Accordingly, embodiments of the sensor system 20 and the modulation circuit 14 may be utilized with welding systems that include the wire feeder 32 and gas source 34 or with systems that do not include a wire feeder 32 and/or a gas source 34 (e.g., embodiments where the weld torch 16 is directly coupled to the power supply 12), depending on implementation-specific considerations.

The illustrated embodiments are directed towards determining position information of the weld torch 16 within the weld region 24 with a modulation circuit 14 and a sensor system 20. Specifically, the illustrated embodiments illustrate systems and methods for transmitting a modulated current output from the power supply 12 and detecting with the sensor system 20 various audio signatures that result from using the modulated current to perform a welding operation at the weld torch 16. In particular, the sensor system 20 may detect the various audio signatures at one or more sensors 22 disposed around the weld torch 16 at predetermined locations. Further, the one or more sensors 22 may transmit the audio signature information detected to a central processing unit 20 of the sensor system 18, which may be configured to determine the position of the weld torch 16 based on the detected audio signature information and based on the known position of each of the one or more sensors 22, as further described in detail below.

In certain embodiments, the modulation circuit 14 may be disposed within the power supply 12, and may be configured to modulate the output of the power supply 12. The modulation circuit 14 may be configured to operate at pre-determined time periods, such that it modulates a portion of the current output at any given time and provides a series of modulated current outputs. In other embodiments, the modulation circuit 14 may be configured to operate continuously during operation of the welding system. Specifically, the modulation circuit 14 may be configured to modulate the current output of the power supply 12 with a randomized signal. For example, in certain embodiments, the modulation circuit 14 may modulate the current output by altering the normal distribution of the current output with a zero-mean function and a randomized variance function. Specifically, the variance of the current output may be randomized with the randomized signal. The randomized signal may be generated or defined as applying an exclusive OR (e.g., XOR) function to a pseudo random noise (PRN) reference sequence and any type of welding information. For example, the randomized signal may be generated by applying an exclusive OR function to the reference PRN sequence and a unique address or location of the power supply 12. The reference PRN sequence may be a repeating bit sequence described by a pre-determined polynomial, which may be determined based on the feedback taps of a Linear Feedback Shift Register (LFSR) (a shift register with input bits that are a linear function of its previous state). As noted above, the welding information may identify and/or represent the unique address of any component of the welding system 10, such as the power supply 12 or the wire feeder 32. Accordingly, in certain embodiments, the random signal utilized by the modulation circuit 14 to modulate the current output of the power supply 12 includes a reference to the specific power supply 12 where the modulation occurs. In addition, the randomized signal utilized by the modulation circuit 14 includes the reference PRN sequence, which may act as a reference point for determining the location of the weld torch 16, as further described below. Further, it should be noted that the modulation circuit 14 is configured to modulate the current output with the randomized signal, such that the current output of the power supply 12 is modulated according to a random signal each time the current output is modulated.

As depicted in the illustrated embodiment, the modulation circuit 14 may be disposed as a component within the power supply 12. It should be noted that in other embodiments, the modulation circuit 14 may be disposed in other components of the welding system 10, such as the wire feeder 32. In certain embodiments, the modulation circuit 14 may be disposed as a component of the power supply control circuitry 42 or as a component of the wire feeder control circuitry 40. For example, the modulation circuit 14 may be built into the supporting logic or control circuitry of the power supply 12 as software controlled closed loop control. For example, the modulation circuit 14 would be disposed within the power supply control circuitry 42 as a sub-routine function within the software, or within an Application Specific Integrated Circuit (ASIC) or Field Programmable Gate Arrat (FPGA). The FPGA may perform closed loop control for the power supply and the modulation circuit 14 may be defined as firmware in the Hardware Definition Language (HDL) source code for the FPGA/ASIC. In embodiments where the modulation circuit 14 is disposed within the wire feeder 32 or the wire feeder control circuitry 40, the modulation circuit 14 may be configured to function substantially similar as if the modulation circuit 14 is disposed within the power supply 12 or the power supply control circuitry 42.

In certain embodiments, the weld cable 44 may be configured to provide the modulated current output 52 to produce the welding arc 26 from the weld torch 16 to the workpiece 28. As described above, this arcing completes an electrical circuit that includes the power supply 12, the weld torch 16, the workpiece 28, and the work cable 50. Particularly, in operation, the modulated current output 52 passes from the power supply 12, through the weld cable 44, to the weld torch 16, and to the workpiece 28, which is typically connected back to the power supply 12 via the work cable 50. Further, as noted above, the welding arc 26 generates a relatively large amount of heat that causes part of the workpiece 28 and the filler metal of the welding wire 36 to transition to a molten state that fuses the materials, forming the weld. In particular, the modulated current output 52 generates an audio signal 54 due to the dynamic heating of the air in proximity to the produced welding arc 26. For example, the expanding and contracting air around the welding arc 26 creates a sound. In particular, the audio signal 54 generated may be representative or directly correlatated to the randomized signal utilized by the modulation circuit 14 to generate the modulated current output 52. Indeed, due to the unique and random nature of the modulated current output 52, the audio signal 54 created may be a unique audio signature that has random and unique audio characteristics (e.g., frequency, range, pitch, compression).

In the illustrated embodiment, the one or more sensors 22 of the sensor system 20 may be configured to detect the audio signals 54 generated when the modulated current output 52 is utilized to produce the welding arc 26. Specifically, the one or more sensors 22 may be disposed anywhere within the weld region 24, and their position may be pre-determined or known by a central processing unit 20 of the sensor system 18. In certain embodiments, the central processing unit 20 may be one of the sensors 22 disposed within the weld region, or may be incorporated into one of the sensors 22. Each of the one or more sensors 22 may be an ultrasonic sensor, such as a passive ultrasonic sensor (e.g., microphone) that is configured to detect the audio signals 54.

In certain embodiments, the sensors 22 may detect the audio signal 54 by employing Direct Sequence Spread Spectrum (DSSS) detection algorithms. As noted above, the randomized signal utilized by the modulation circuit 14 may be generated as an XOR function of welding data and a reference PRN sequence. In addition, the detected audio signal 54 may include the welding data transmitted and a delayed PRN sequence. In certain embodiments, the DSSS detection algorithm may extract the welding data (e.g., the unique address of the power supply 12) from the audio signal 54. Further, the DSSS detection algorithms may be configured to determine PRN delay information which may be correlated to the distance between each sensor 22 and the weld torch 16. For example, each sensor 12 may be configured to apply an autocorrelation process to the detected audio signal 54. The autocorrelation process may involve a comparison of the reference PRN sequence utilized by the modulation circuit 14 with the delayed PRN sequence received through the audio signal 54. When “code lock” is achieved by the autocorrelation process, each sensor 22 may be able to determine not only the original information (e.g., the address of power supply 12), but also PRN delay information, which may be correlated to an estimate of the distance between the welding arc 26 and the sensor 22 receiving the audio signal 54. Accordingly, each sensor 22 within the welding system 10 utilizes this autocorrelation process to determine the address of the power supply 12 and the distance between the sensor 22 and the weld torch 16. In this manner, a plurality of sensors 22 disposed at prior known locations within the weld region 24 may detect the audio signal 54 and determine an estimate of the distance between the sensor 22 and the weld torch 16.

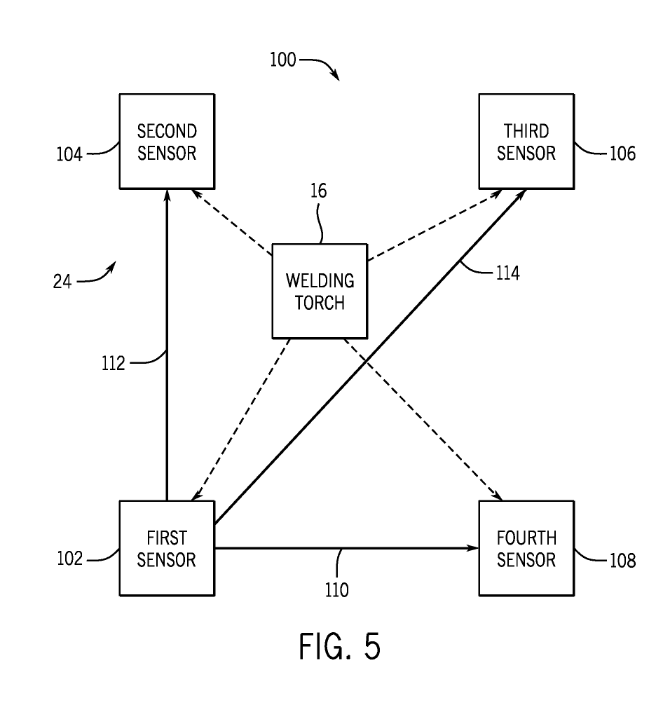

In certain embodiments, each sensor 22 may be configured to transmit the determined distance information (e.g., the determined estimate of the distance between the sensor 22 and welding arc 26) and the original address of the power supply 12 to the central processing unit 20 of the sensor system 18. The central processing unit 20 may include one or more processors 56, a memory 58, and a storage 60. In certain embodiments, each sensor 22 may additionally or alternatively include the processor 56, the memory 58, and storage 60. Specifically, the central processing unit 20 may be configured to determine the exact position (e.g., location) of the weld torch 16 based on the distance information received from each sensor 22. Specifically, the central processing unit 20 may be configured to determine the position of the weld torch 16 based on the geometry of the sensors 22 and the mathematics of triangulation, as further described with respect to FIG. 5. In certain embodiments, the determined position of the weld torch 16 may be provided to components of the welding system 10 (e.g., the power supply 12, the wire feeder 32), and these components may utilize the position information to ensure that the operator is performing an efficient and/or accurate weld, to control or adjust an operating parameter (e.g., wire speed, voltage output) of the welding system 10, to determine a new operating parameter of the welding system 10, to halt welding operations, or any combination thereof. In certain embodiments, the central processing unit 20 may utilize the welding data (e.g., the address of the power supply 12) to determine where to send the position information. In other embodiments, the central processing unit 20 may utilize the welding data to confirm that the audio signal 54 being processed is derived from the correct power supply 12 when multiple power supplies are disposed within the weld location.

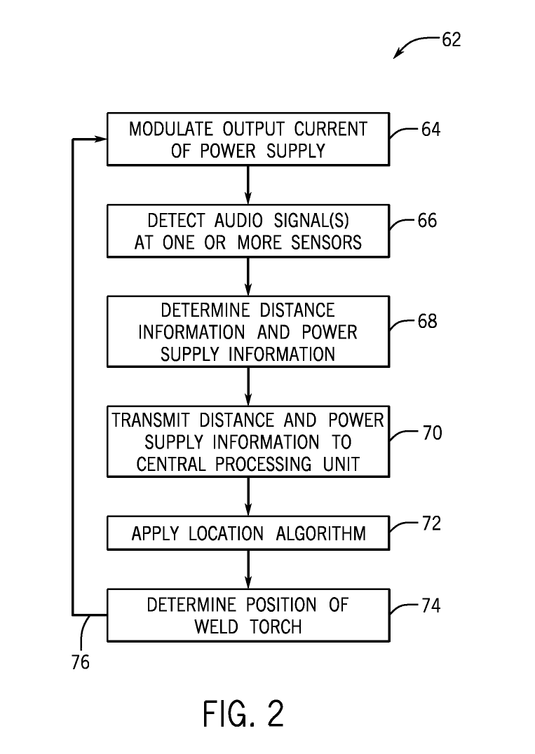

FIG. 2 is a flow diagram of an embodiment of a method 62 for determining a position of the weld torch 16 within the weld region 24 that may be used by the welding system 10 of FIG. 1. In certain embodiments, the method 62 begins with a modulation circuit 14 that modulates the current output of the power supply 12 to generate a modulated current output 52 (block 54). In particular, the modulation circuit 14 may utilize a randomized signal to produce the modulated current output 52. The randomized signal may be generated as an XOR function between a reference PRN sequence and welding data. In certain embodiments, the welding data includes information related to the unique address of the power supply 12 where the modulation occurs. As noted above, the modulated current output 52 may be utilized by the weld torch 16 to produce a welding arc 26 and an audio signal 54. The audio signal 54 may be representative or indicative of the randomized signal utilized to modulate the current output. Furthermore, due to the random nature of the signal used to modulate the modulated current output 52, the audio signal 54 may include unique audio characteristics.

In certain embodiments, the method 62 includes one or more sensors 22 that are each configured to detect the one or more audio signals 54 produced as a result of the welding arc 26 (block 66). Further, each sensor 22 may utilize the detected audio signal(s) 54 to determine an estimate of the distance between the sensor 22 and the welding arc 26 (block 68). In addition, each sensor 22 may utilize the detected audio signal(s) 54 to determine or extract the unique address of the power supply 12 where the current output was modulated (block 68). Further, the method 62 includes each sensor 22 transmitting the determined distance information and/or the power supply information to the central processing unit 20 of the sensor system 18 (block 70). The central processing unit 20 may be configured to apply a location algorithm to the distance information and the power supply information received from each of the one or more sensors 22, as further described with respect to FIG. 5 (block 72). In particular, the central processing unit 20 may utilize the location algorithm to determine the position of the weld torch 16 within the weld region 24 (block 74).

It should be noted that the method 62 may be utilized to determine the position of the weld torch 16 during the welding operation and/or as the weld torch 16 is moving. For example, the method 62 may additionally be utilized as a feedback loop 76 to continuously (or at pre-determined increments) determine the position of the weld torch 16 within the weld region 24.

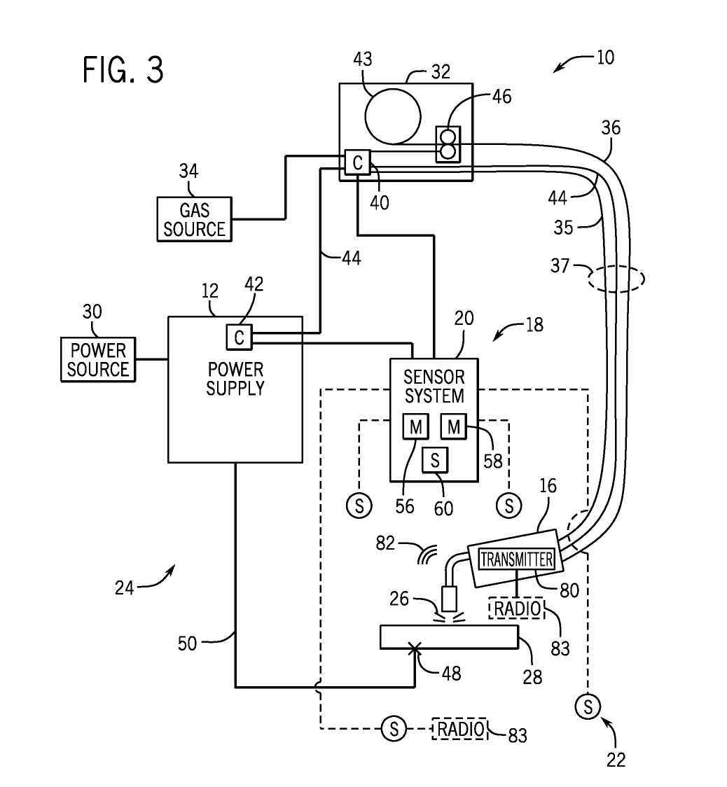

FIG. 3 is a block diagram of an embodiment of the welding system of FIG. 1 utilizing the power supply 12, the weld torch 16 equipped with a transmitter 80, and the sensor system 18 having the one or more sensors 22 disposed within the weld region 24. As noted above with respect to FIG. 1, the modulation circuit 14 disposed within the power supply 12 may be utilized to modulate the current output of the power supply 12 to generate a random modulated current output 52. Further, when the weld torch 16 utilizes the modulated current output 52 to generate the welding arc 26, an audio signal 54 may be produced and later detected by the sensors 21. However, in the illustrated embodiment of FIG. 3, the transmitter 80 (e.g., a pulsed ultrasonic transmitter) disposed within the weld torch 16 may be utilized to generate and transmit pulsed audio signals 82 that are detected by the one or more sensors 22 and the modulation circuit 14 may not be utilized or included.

In certain embodiments, for example, the transmitter 80 may be configured to generate the pulsed audio signals 82 with a randomized signal. Specifically, the randomized signal may include a reference PRN sequence and a unique address (to uniquely identify the weld torch 16) of the weld torch 16, and may be utilized by the transmitter 80 to generate the pulsed audio signals 82. As similarly noted above with respect to FIG. 1, the sensors 22 may each be configured to detect the pulsed audio signals 82. Further, each sensor 22 may be configured to determine distance information (e.g., an estimate of the distance between the sensor 22 and the transmitter 80) with a comparison of the reference PRN sequence and the detected delay PRN sequence of the pulsed audio signals 82. Further, each sensor 22 may extract weld torch information (e.g., the unique address of the weld torch 16) from the detect pulsed audio signals 82. Specifically, the sensors 22 may utilize the DSSS detection algorithm to determine the distance information and the weld torch information.

In certain embodiments, each sensor 22 may additionally or alternatively utilize a comparison between a reference time and the arrival time of each pulsed audio signal 82 to determine time delay information. For example, the central processing unit 20 of the sensor system 18 may maintain and control a reference time (e.g., host time, local time standard), and each sensor 22 may compare the reference time to the arrival time of the pulsed audio signal 82 to determine a time delay estimate. In certain embodiments, the time delay estimates of each sensor 22 may be utilized to generate an estimate of the distance information between each sensor 22 and the transmitter 80. For example, if the distance between a first sensor 22 and the transmitter 80 is less than the distance between a second sensor 22 and the transmitter 80, the time delay between the first sensor 22 and the transmitter 80 will be less than the time delay estimate between the second sensor 22 and the transmitter 80.

In certain embodiments, each sensor 22 and the transmitter 80 may be coupled to a radio 83. For example, each radio 83 may be configured as part of a wireless network within the welding system 10. Further, the radio 83 coupled to each sensor 22 may periodically transmit an interrogation request to the radio 83 coupled to the transmitter 80. In particular, the interrogation request transmitted by the radio 83 coupled to the sensor 22 may include a time stamp corresponding to the time of the interrogation request transmission and the location (the specific sensor 22) from which the interrogation request originates. Further, the transmitter 80 may transmit a reply to the sensor 22 from where the interrogation request was transmitted. In particular, the reply to the interrogation request includes the original time stamp and location information. Accordingly, when the radio 83 coupled to the sensor 22 receives the reply from the transmitter 80, the sensor 22 may be able to determine an estimate of the time delay between the sensor 22 and the transmitter 80. Further, the sensor 22 may know the static delays (e.g., time to process data, time to send data through the hardware of the radio 83), and may be configured to subtract the static delays when determining an estimate of the time delay. Particularly, in this embodiment, a reference time may not be needed by each sensor 22, since the transmitted time of the interrogation request is compared to the returning arrival time of the reply. It should be noted that each sensor 22 does not need to be correlated to one another, since only a relative time delay estimate is generated. In certain embodiments, this technique may be utilized with the DSSS signal, thereby incorporating the location of the sensor 22 where the interrogation request originates into the data transmission.

In other embodiments, the transmitter 80 may be configured to transmit an analog chirp FM signal or waveform. Specifically, the analog chirp FM signal or waveform is a tone with constant amplitude which varies in frequency as a function of time. Accordingly, the sensor 22 may be configured to make the interrogation request to the transmitter 80, and the transmitter 80 may be configured to transmit an analog chirp FM signal as the reply signal. In particular, the analog chirp FM signal or waveform may incorporate the time stamp information of the interrogation request. It should be noted that the time length of the chirp signal may be varied by the transmitter 80 to achieve better processing gain for a stronger signal. Further, each sensor 22 receiving the analog chirp FM signal may be configured to match and apply an inverse filter to generate an narrow pulse response with an enhanced signal to noise ratio. Particularly, the narrowness of the received pulse and the added signal to noise ratio may decrease the measurement variance and enhance the measurement accuracy.

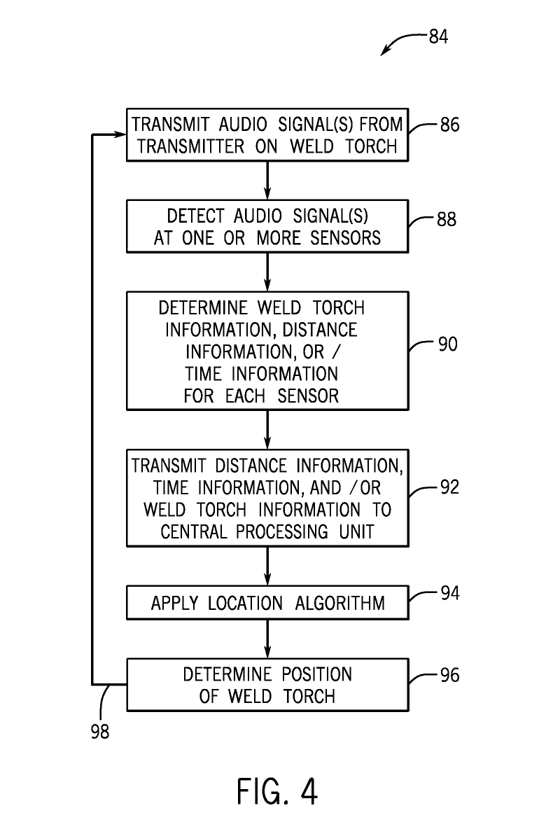

FIG. 4 is a flow diagram of an embodiment of a method 84 for determining a position (e.g., location, location information, position information) of the weld torch 16 within the weld region 24 that may be used by the welding system 10 of FIG. 3. In certain embodiments, the method 84 begins with the transmitter 80 disposed on the weld torch 16 that transmits a pulsed audio signal 82 (block 86). In particular, in certain embodiments, the transmitter 80 may utilize a randomized signal comprising a reference PRN sequence and/or welding data (e.g., address of the weld torch 16 or transmitter 80) to produce the pulsed audio signal 82. Furthermore, due to the random nature of the signal used to generate the pulsed audio signals 82, the pulsed audio signals 82 may include unique audio characteristics.

In certain embodiments, the method 84 includes one or more sensors 22 that are each configured to detect the one or more pulsed audio signals 82 (block 88). Further, each sensor 22 may utilize the detected pulsed audio signals 82 to determine an estimate of the distance between the sensor 22 and the transmitter 80 (block 90). For example, in certain embodiments, a comparison of the reference PRN sequence to the received delayed PRN sequence within the pulsed audio signal 82 may generate delay information that is related to the distance between the sensor 22 and the transmitter 80. Further, each sensor 22 may utilize the pulsed audio signals 82 to extract the welding data from the pulsed audio signal (e.g., the unique address of the weld torch 16 where the transmitter 80 is disposed) (block 90). In addition, in certain embodiments, each sensor 22 may utilize the pulsed audio signals 82 to determine time delay information that correlates to the distance information (block 90).

Further, the method 84 includes each sensor 22 transmitting the determined distance information, time information, and/or the weld torch information to the central processing unit 20 of the sensor system 18 (block 92). The central processing unit 20 may be configured to apply a location algorithm to the time information, the distance information, and/or the weld torch information received from each of the one or more sensors 22, as further described with respect to FIG. 5 (block 94). In particular, the central processing unit 20 may utilize the location algorithm to determine the position (e.g., location) of the weld torch 16 within the weld region 24 (block 96).

It should be noted that the method 84 may be utilized to determine the position of the weld torch 16 during the welding operation and/or as the weld torch 16 is moving. For example, the method 84 may additionally be utilized as a feedback loop 98 to continuously (or at pre-determined increments) determine the position of the weld torch 16 within the weld region 24.

FIG. 5 is a block diagram of an embodiment of a system 100 for determining a position (e.g., location) of the weld torch 16 of FIG. 1 or FIG. 3, where a mathematical relationship may be the basis of the location algorithm utilized by the central processing unit 20 of the sensor system 18. The mathematical relationship can be seen in the arrangement of the system 100. The system 100 may additionally illustrate the geometric relationship between the sensors 22 and the weld torch 16. Specifically, in the illustrated embodiment, a first sensor 102, a second sensor 104, a third sensor 106, and a fourth sensor 108 are disposed within the weld region 24 proximate to the weld torch 16. In particular, the position or location of each sensor 22 is known by the central processing unit 20. For illustrative purposes, an imaginary Cartesian Coordinate System may be created between the first sensor 102, the second sensor 104, the third sensor 106, and the fourth sensor 108. For example, an X-axis 110 may be created between the first sensor 102 and the fourth sensor 108, a Y-axis 112 may be created between the first sensor 102 and the second sensor 104, and a Z-axis 114 may be created between the first sensor 102 and the third sensor 106.

As noted above, in certain embodiments, each sensor 22 (e.g., first sensor 102, the second sensor 104, the third sensor 106, and the fourth sensor 108) may be configured to determine distance information or time information based on the techniques or methods described with respect to FIGS. 1-4. Specifically, the distance or time information may be an estimate of the distance between each sensor 22 and the weld torch 16. For example, in the illustrated embodiment, the first sensor 102 may be configured to calculate an estimate of a first distance 116 between the first sensor 102 and the weld torch 16. Likewise, the second sensor 104 may be configured to calculate an estimate of a second distance 118 between the second sensor 104 and the weld torch 16, the third sensor 106 may be configured to calculate an estimate of a third distance 120 between the third sensor 106 and the weld torch 16, and the fourth sensor 108 may be configured to calculate an estimate of a fourth distance 122 between the fourth sensor 108 and the weld torch 16.

In particular, these distance estimates (e.g., distance information), or in some embodiments, the time delay estimates (e.g., time or time delay information), may be provided to the central processing unit 20 of the sensor system 18. The central processing unit 20 may be configured to determine position information of the weld torch 16 based on the received information using the mathematics of triangulation. For example, as noted above, the weld torch 16 may be disposed at some location within the imaginary XYZ Cartesian space, and the central processing unit 20 may be configured to determine the location of the weld torch 16 within this space by utilizing the distance information and/or the time information calculated by the sensors 22. Further it should be noted that the position information determined for the weld torch 16 may be relative position information, in that it may not an absolute location relative to the earth but rather a location relative to the sensor system 18 and/or the welding system 10.

Accordingly, while four sensors are utilized in the illustrated embodiment, it should be noted that any number of sensors 22 greater than four may be utilized to create the imaginary XYZ Cartesian space. For example, if five or more sensors 22 are utilized within the weld region 24, any four of the five sensors 22 may be utilized for determining the position of the weld torch 16.

While only certain embodiments have been illustrated and described herein, many modifications and changes will occur to those skilled in the art. It is, therefore, to be understood that the appended claims are intended to cover all such modifications and changes as fall within the true spirit of the disclosure.

1. A welding system, comprising:
a modulation circuit configured to modulate a welding current with a randomized signal to generate a modulated welding current;
a weld torch configured to receive the modulated welding current, wherein the weld torch is configured to produce a welding arc based on the received modulated welding current, and wherein an audio signal is generated when the weld torch produces the welding arc based on the modulated welding current;
one or more sensors of a sensor system disposed in a welding region proximate to the weld torch, wherein each sensor of the one or more sensors is configured to detect the audio signal, and the sensor system is configured to provide information regarding the audio signal; and
a central processing unit disposed within the sensor system configured to receive the information regarding the audio signal from each sensor of the one or more sensors, wherein the central processing unit is configured to calculate position information for the weld torch based on the information regarding the audio signal received from the one or more sensors.

2. The welding system of claim 1, wherein the sensor system comprises processing circuitry configured to provide distance information that is indicative of a distance between the respective sensor and the welding arc as the information regarding the audio signal.

3. The welding system of claim 1, wherein the weld torch is configured to receive the welding current and produce the welding arc based on the welding current during unmodulated operation.

4. The welding system of claim 1, wherein each of the one or more sensors comprise an ultrasonic sensor.

5. The welding system of claim 1, comprising control circuitry disposed within a welding power supply, wherein the modulation circuit is disposed within the control circuitry of the welding power supply.

6. The welding system of claim 1, comprising control circuitry disposed within a wire feeder, wherein the modulation circuit is disposed within the control circuitry of the wire feeder.

7. The welding system of claim 1, wherein the modulation circuit is configured to generate the modulated welding current based at least in part on a reference pseudo random noise sequence and a unique identifier of a welding power supply or a wire feeder within which the modulation circuit is disposed.

8. The welding system of claim 7, wherein the one or more sensors includes processing circuitry configured to determine the unique identifier of the welding power supply or the wire feeder.

9. The welding system of claim 1, wherein the modulation circuit is configured to modulate the welding current with a series of randomized signals to generate a series of modulated welding currents during a time period.

10. The welding system of claim 9, wherein each modulated welding current of the series of modulated welding currents has unique characteristics based on the random nature of each randomized signal of the series of randomized signals, and wherein a series of unique audio signals are generated when the weld torch produces the welding arc based on the series of modulated welding currents.

11. The welding system of claim 1, wherein each of the one or more sensors are disposed at a known or predetermined location within the welding region.

12. A welding system, comprising:
a weld torch configured to produce a welding arc;
a transmitter disposed within the weld torch, wherein the transmitter is configured transmit an audio signal into a welding region;
one or more sensors of a sensor system disposed in the welding region proximate to the weld torch, wherein each sensor of the one or more sensors is configured to detect the audio signal and calculate distance information or time delay information based on the detected audio signal; and
a central processing unit of the sensor system configured to receive the distance information or the time delay information from each sensor of the one or more sensors, wherein the central processing unit is configured to calculate position information for the weld torch based on the distance information or the time delay information received from the one or more sensors.

13. The welding system of claim 12, wherein the transmitter is configured to generate the audio signal based on a randomized signal.

14. The welding system of claim 12, wherein the transmitter is configured to generate the audio signal based at least in part on a reference pseudo random noise sequence and a unique identifier of the weld torch.

15. The welding system of claim 12, wherein the central processing unit is configured to control a reference time for each of the one or more sensors.

16. The welding system of claim 15, wherein each of the one or more sensors is configured to compare the reference time to an arrival time of the audio signal to determine the time delay information.

17. The welding system of claim 12, wherein the transmitter and each of the one or more sensors are coupled to a radio.

18. The welding system of claim 17, wherein each sensor of the one or more sensors is configured to transmit an interrogation request to the transmitter via the radio, and wherein the transmitter is configured to detect and respond to the interrogation request with a reply signal via the radio.

19. The welding system of claim 18, wherein the reply signal comprises a time stamp of a transmission time of the interrogation request.

20. The welding system of claim 19, wherein each of the one or more sensors is configured to receive the reply signal and to determine the time delay information based on a comparison of the transmission time of the interrogation request and the arrival time of the reply signal.

21. A method, comprising:
generating an audio signal from a weld torch disposed within a weld region of a welding system;
detecting the audio signal with one or more sensors of a sensor system disposed within the weld region;
determining, with each of the one or more sensors, distance information based on the detected audio signal, wherein the distance information comprises a distance between each of the one or more sensors and the weld torch;
transmitting the distance information from each of the one or more sensors to a central processing unit of the sensor system; and
determining position information of the weld torch within the weld region based on the distance information received from each of the one or more sensors.

22. The method of claim 21, comprising generating the audio signal from a transmitter disposed within the weld torch.

23. The method of claim 21, comprising generating the audio signal based on a modulated welding current provided by a welding power supply or wire feeder.
